(19) United States
(12) Patent Application Publication
(10) Pub. No.: US 2006/0054865 A1
(43) Pub. Date: Mar. 16, 2006

(54) Fischer-Tropsch naphtha as blendstock for denatured alcohol

(75) Inventors: Douglas L. Smith, Katy, TX (US); Keith H. Lawson, Ponca City, OK (US); Priya Rangarajan, Ponca City, OK (US); Oluwaseyi A. Odueyungbo, Ponca City, OK (US)

Correspondence Address: DAVID W. WESTPHAL;CONOCOPHILLIPS COMPANY - I.P. Legal, P.O. BOX 1267, PONONCA CITY, OK, 74602-1267, US

(73) Assignee: ConocoPhillips Company, Houston, TX (US)

(21) Appl. No.: 10/940,172

(22) Filed: Sep. 14, 2004

(51) Int. Cl. C12F 5/00

(52) U.S. Cl. 252/366

(57) ABSTRACT

The invention includes a denatured liquid and a method for making the same. In one embodiment, the method comprises feeding a syngas to a hydrocarbon synthesis reactor, wherein the syngas is reacted to produce a hydrocarbon synthesis product. A naphtha is produced from the hydrocarbon synthesis product and combined with a liquid to denature the liquid. In other embodiments, the denatured liquid comprises ethanol.

### BACKGROUND OF THE INVENTION

1. Field of the Invention

This invention relates to the field of denaturants and more specifically to the field of using Fischer-Tropsch naphtha as a denaturant.

2. Background of the Invention

Natural gas, found in deposits in the earth, is an abundant energy resource. For example, natural gas commonly serves as a fuel for heating, cooking, and power generation, among other things. The process of obtaining natural gas from an earth formation typically includes drilling a well into the formation. Wells that provide natural gas are often remote from locations with a demand for the consumption of the natural gas.

Thus, natural gas is conventionally transported large distances from the wellhead to commercial destinations in pipelines. This transportation presents technological challenges due in part to the large volume occupied by a gas. Because the volume of a gas is so much greater than the volume of a liquid containing the same number of gas molecules, the process of transporting natural gas typically includes chilling and/or pressurizing the natural gas in order to liquefy it, which contributes to the final cost of the natural gas.

Further, naturally occurring sources of crude oil used for liquid fuels such as gasoline and middle distillates have been decreasing and supplies are not expected to meet demand in the coming years. Middle distillates typically include heating oil, jet fuel, diesel fuel, and kerosene. Fuels that are liquid under standard atmospheric conditions have the advantage that, in addition to their value, they can be transported more easily in a pipeline than natural gas, since they do not require the energy, equipment, and expense required for liquefaction.

Thus, for all of the above-described reasons, there has been interest in developing technologies for converting natural gas to more readily transportable liquid fuels, i.e. to fuels that are liquid at standard temperatures and pressures. One method for converting natural gas to liquid fuels involves two sequential chemical transformations. In the first transformation, natural gas or methane, the major chemical component of natural gas, is reacted with oxygen and/or water to form synthesis gas, also called syngas, which is a combination of carbon monoxide gas and hydrogen gas. In the second transformation, known as the Fischer-Tropsch process, carbon monoxide and hydrogen are converted into a mixture of organic molecules containing carbon and hydrogen. Those organic molecules containing mainly carbon and hydrogen are known as hydrocarbons. In addition, some hydrocarbons such as oxygenates that contain oxygen in addition to carbon and hydrogen may be formed during the Fischer-Tropsch process. Hydrocarbons having saturated carbon-carbon bonds are known as paraffins and hydrocarbons having at least one unsaturated carbon-carbon C═C bond are known as olefins. When the carbons are linked in a straight chain, the paraffins are called “normal paraffins.” When the carbon backbone is branched, the paraffins are called “isoparaffins.” Paraffins are particularly desirable as the basis of synthetic diesel fuel.

Typically, the Fischer-Tropsch product stream contains hydrocarbons having a range of numbers of carbon atoms and thus having a range of molecular weights. Therefore, the Fischer-Tropsch products produced by conversion of natural gas commonly contain a range of hydrocarbons including gases, liquids and waxes. Depending on the molecular weight product distribution, different Fischer-Tropsch product mixtures are ideally suited to different uses. For example, Fischer-Tropsch product mixtures containing liquids may be processed to yield gasoline, as well as heavier middle distillates. Hydrocarbon waxes may be subjected to an additional processing step for conversion to liquid and/or gaseous hydrocarbons. Thus, in the production of a Fischer-Tropsch product stream for processing to a fuel, it is desirable to obtain primarily hydrocarbons that are liquids and waxes, which are nongaseous hydrocarbons (e.g., C₅₊ hydrocarbons). Fischer-Tropsch products may also be used as a blendstock with other liquids.

In addition to the need for converting natural gas to liquid fuels, current environmental and regulatory concerns along with decreasing sources of crude oil have also increased the demand for the alternative fuel ethanol. Ethanol has typically been used as a blend with gasoline for use as a fuel. Ethanol has also been used for non-fuel applications such as rubbing alcohol. However, regulatory and statutory concerns typically require ethanol to be denatured. To denature the ethanol, conventional denaturants such as methanol, chloroform, ethyl acetate, gasoline, isopropyl alcohol, vinegar, benzene, diethyl phthalate, toluene, oil refinery naphtha, and the like have typically been blended with ethanol in suitable quantities to denature the ethanol in regards to the pertinent regulatory and statutory requirements.

Drawbacks to blending with these conventional denaturants include the denatured ethanol having toxicity and properties that adversely affect its use for fuel purposes. For instance, naphtha produced by refining crude oil or tar sands typically has significant levels of sulfur. Therefore, an ethanol that is to be used as a fuel blending agent, if denatured with the use of the refinery naphtha, can result in toxic (i.e., sulfur) emissions that exceed allowed levels as per regulatory and statutory requirements. In addition, the denaturant methanol is volatile and may have adverse human health implications. Additional drawbacks to blending with these conventional denaturants include the denatured ethanol having properties that exceed gasoline specification regulations. For instance, gasoline regulations typically require a sulfur content of less than about 10 ppm. When a gasoline is blended with an ethanol denatured with the conventional denaturants (such as refinery naphtha), the gasoline can exceed the sulfur content. Additional regulated property requirements of gasoline such as Reid Vapor Pressure and benzene content may also be exceeded. In addition, drawbacks also include the cost efficiency of blending the ethanol with the conventional denaturants.

Consequently, there is a need for an improved method for denaturing ethanol. In addition, a need exists for an improved denaturant for ethanol. Additional needs include a denatured ethanol that is non-toxic. Further needs include a denatured ethanol that when blended with gasoline will not cause the gasoline to exceed specification requirements. In addition, a need exists for a more efficient and effective method for denaturing ethanol to meet regulatory and statutory requirements.

### BRIEF SUMMARY OF SOME OF THE PREFERRED EMBODIMENTS

These and other needs in the art are addressed in one embodiment by a denatured liquid. The denatured liquid comprises a liquid and a naphtha, wherein the naphtha is derived at least in part by a hydrocarbon synthesis process, such as employing the Fischer-Tropsch synthesis.

In another embodiment, the invention provides a liquid product. The liquid product comprises a denatured liquid, wherein the denatured liquid comprises a naphtha. The naphtha is derived at least in part by a Fischer-Tropsch synthesis and a second liquid.

An additional embodiment comprises a method for denaturing a liquid with a naphtha, wherein the naphtha is derived at least in part by a Fischer-Tropsch synthesis. The method comprises exposing the liquid to the naphtha; and combining the liquid with an amount of the naphtha sufficient to denature the liquid.

A further embodiment comprises a method for producing a denatured liquid. The method comprises feeding a syngas to a hydrocarbon synthesis reactor, wherein the syngas is reacted to produce a hydrocarbon synthesis product; hydroprocessing at least a portion of the hydrocarbon synthesis product to produce a naphtha from the hydrocarbon synthesis product; and combining an amount of the naphtha with the liquid sufficient to denature the liquid. The hydroprocessing of at least a portion of the hydrocarbon synthesis product to produce a naphtha may comprise hydrotreating at least a portion of the hydrocarbon synthesis product and fractionating the hydrotreated hydrocarbon synthesis product to produce a portion of the naphtha. The hydroprocessing may comprise hydrocracking at least a portion of the hydrocarbon synthesis product and fractionating the hydrocracked hydrocarbon synthesis product to produce a portion of the naphtha.

A suitable denaturant comprising naphtha preferably has a high content in paraffins, which have not more than about 11 carbon atoms. More preferably, the suitable denaturant comprising naphtha has a high content in paraffins with a carbon number between 5 and 9. Additionally, the suitable denaturant comprising naphtha has a very low sulfur content (i.e., less than 50 ppm S, preferably less than 20 ppm S, more preferably less than 10 ppm S). The suitable denaturant comprising naphtha preferably also a low aromatic content (i.e., less than 10,000 ppm, preferably less than 1,000 ppm, more preferably less than 500 ppm). Preferably, the majority of the denaturant comprises naphtha derived from a hydrocarbon synthesis product. The denaturant may also comprise some amounts of one or more conventional denaturants such as methanol, chloroform, ethyl acetate, gasoline, isopropyl alcohol, vinegar, benzene, diethyl phthalate, toluene, fossil fuel-derived naphtha, and the like. In addition, a portion of the components of the denaturant may also be derived from biomass.

In alternative embodiments, the liquid is ethanol. Additional alternative embodiments include combining the denatured liquid with at least one of a personal care product (such as cosmetic), a fuel, antifreeze, chemicals, and rubbing alcohol.

It will therefore be seen that the technical advantages of this invention include the Fischer-Tropsch naphtha providing a low sulfur and low aromatic denaturant for ethanol, thereby eliminating problems encountered by using conventional denaturants such as refinery naphtha. For instance, refinery naphtha has such levels of aromatics and sulfur that soot formation can be enhanced. Further advantages include a better biodegradability than conventional denaturants such as methanol and refinery naphtha, and a visible flame as compared to methanol.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIG. 1 illustrates a hydrocarbon synthesis reactor, a hydrotreater and a fractionator;

FIG. 2 illustrates a hydrocarbon synthesis reactor, a hydrocracker and a fractionator; and

FIG. 3 illustrates a hydrocarbon synthesis reactor, a hydrotreater, a fractionator, and a hydrocracker.

### DETAILED DESCRIPTION OF THE PREFERRED EMBODIMENTS

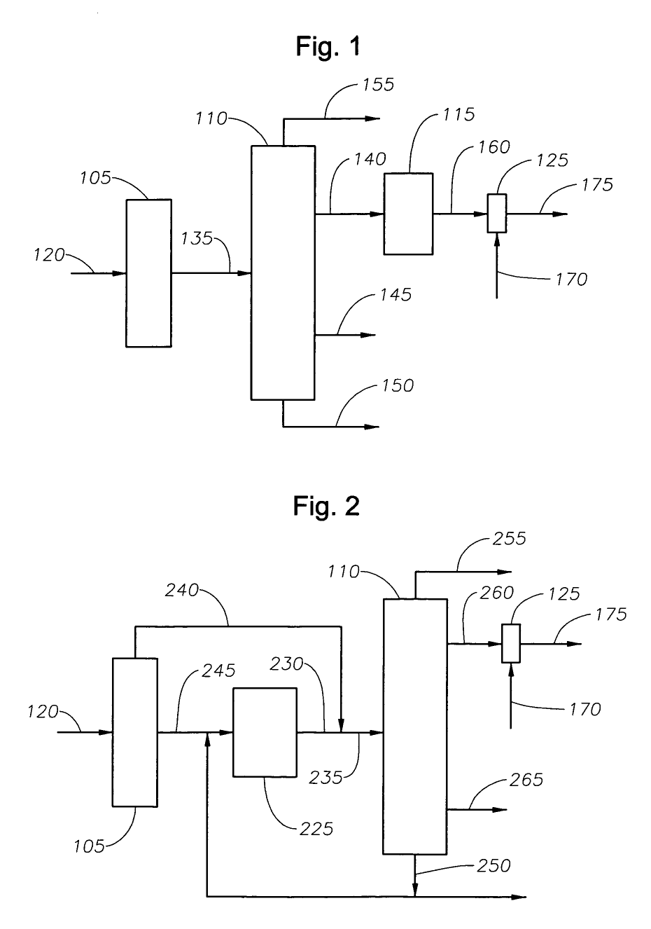

FIG. 1 illustrates a hydrocarbon synthesis system comprising a hydrocarbon synthesis reactor 105, a fractionator 110, a hydrotreater 115, and a vessel 125.

Hydrocarbon synthesis reactor 105 comprises any reactor in which hydrocarbons are produced from syngas by Fischer-Tropsch synthesis, alcohol synthesis, and any other suitable synthesis. Hydrocarbon synthesis reactor 105 is preferably a Fischer-Tropsch reactor. Preferably, the hydrogen is provided by free hydrogen, although some Fischer-Tropsch catalysts have sufficient water gas shift activity to convert some water to hydrogen for use in the Fischer-Tropsch synthesis.

As illustrated in FIG. 1, a syngas feed 120 is fed to hydrocarbon synthesis reactor 105. Syngas feed 120 comprises hydrogen and carbon monoxide. It is preferred that the molar ratio of hydrogen to carbon monoxide in syngas feed 120 be greater than 0.5:1 (e.g., from about 0.67 to about 2.5). Preferably, when cobalt, nickel, iron, and/or ruthenium catalysts are used, syngas feed 120 comprises hydrogen and carbon monoxide in a molar ratio of about 1.4:1 to about 2.3:1. Syngas feed 120 may also comprise carbon dioxide. Moreover, syngas feed 120 preferably comprises a low concentration of compounds or elements that have a deleterious effect on the catalyst, such as poisons. For example, syngas feed 120 may be pretreated to ensure that it contains low concentrations of sulfur or nitrogen compounds such as hydrogen sulfide, hydrogen cyanide, ammonia and carbonyl sulfides. Syngas feed 120 is contacted with the catalyst in a reaction zone. Mechanical arrangements of conventional design may be employed as the reaction zone including, for example, fixed bed, fluidized bed, slurry bubble column or ebullating bed reactors, among others. Accordingly, the preferred size and physical form of the catalyst particles may vary depending on the reactor in which they are to be used.

Hydrocarbon synthesis reactor 105 is typically run in a continuous mode. In this mode, the gas hourly space velocity through the reaction zone typically may range from about 50 to about 10,000 hr⁻¹, preferably from about 300 hr⁻¹ to about 2,000 hr⁻¹. The gas hourly space velocity is defined as the volume of reactants per time per reaction zone volume. The volume of reactant gases is preferably at, but not limited to, standard conditions of pressure (101 kPa) and temperature (0° C.). The reaction zone volume is defined by the portion of the reaction vessel volume in which the reaction takes place and that is occupied by a gaseous phase comprising reactants, products and/or inerts; a liquid phase comprising liquid/wax products and/or other liquids; and a solid phase comprising catalyst. The reaction zone temperature is typically in the range from about 160° C. to about 300° C. Preferably, the reaction zone is operated at conversion promoting conditions at temperatures from about 190° C. to about 260° C., more preferably from about 205° C. to about 230° C. The reaction zone pressure is typically in the range of about 80 psia (552 kPa) to about 1,000 psia (6,895 kPa), more preferably from 80 psia (552 kPa) to about 800 psia (5,515 kPa), and still more preferably from about 140 psia (965 kPa) to about 750 psia (5,170 kPa). Most preferably, the reaction zone pressure is from about 250 psia (1,720 kPa) to about 650 psia (4,480 kPa).

Hydrocarbon synthesis reactor 105 produces at least one hydrocarbon synthesis product 135, which primarily comprises hydrocarbons, which include paraffins and olefins. Hydrocarbon synthesis product 135 may also comprise oxygen-containing hydrocarbonaceous compounds, also called oxygenates, such as alcohols, aldehydes, and the like. Hydrocarbon synthesis product 135 preferably comprises primarily hydrocarbons with 5 or more carbons atoms. Hydrocarbon synthesis product 135 is fed to fractionator 110 where it is separated into distillation cuts, which comprise middle distillates including a straight-run naphtha distillate 140 and a straight-run diesel distillate 145, a straight-run heavy distillate 150, and a straight-run light distillate 155. It is to be understood that the present invention is not limited to one naphtha distillate 140 and one diesel distillate 145 but can comprise one distillate that combines both. The distillation can generate two or more naphtha distillates and/or two or more diesel distillates, one with a higher boiling point range than the other distillate(s). Methods of fractionation are well known in the art, and fractionator feed 135 can be fractionated in fractionator 110 by any suitable fractionation method, such as atmospheric distillation, vacuum distillation, and short-path distillation.

Straight-run naphtha distillate 140 may be fed to hydrotreater 115 for hydrotreatment to form a hydrotreated naphtha product 160. The hydrotreatment saturates at least a portion of the olefins in straight-run naphtha distillate 140. The hydrotreatment may substantially convert all of the oxygenates to paraffins or may allow a substantial amount of the oxygenates to remain unconverted. The hydrotreatment can take place over hydrotreating catalysts. In alternative embodiments (not illustrated), straight-run diesel distillate 145 may be similarly fed to a hydrotreater for hydrotreatment to produce a hydrotreated diesel product. Depending on the selection of the catalyst and temperature, the hydrotreatment in hydrotreater 115 may have a mild severity in such a manner that olefins and oxygenates are all substantially converted or have an ultra-low severity in such a manner that some oxygenates remain in hydrotreated naphtha product 160. The hydrotreating catalyst used in hydrotreater 115 comprise at least one metal from Groups 6, 8, 9, and 10 of the Periodic Table. Without limitation, examples of such metals include molybdenum, tungsten, nickel, palladium, platinum, ruthenium, iron, and cobalt. Catalysts comprising nickel, palladium, platinum, tungsten, molybdenum, ruthenium, and combinations thereof are typically highly active, and catalysts comprising iron and/or cobalt are typically less active catalysts. It should be understood that hydrotreatment catalysts can comprise promoters and can be conducted with or without support, although preferably supported. Preferably, hydrotreater 115 comprises a nickel catalyst.

For the highly active catalysts, the hydrotreatment is preferably conducted at temperatures from about 80° C. to about 250° C., more preferably from about 80° C. to about 235° C., and most preferably from about 80° C. to about 220° C. For ultra-low severity hydrotreatment with such highly active catalysts, the temperature can be from about 80° C. to about 180° C., more preferably from about 80° C. to about 160° C., and most preferably from about 80° C. to about 150° C. For the less active catalysts (iron and/or cobalt), the hydrotreatment is preferably conducted at temperatures from about 180° C. to about 350° C. For ultra-low severity hydrotreatment with such less active catalysts, the temperature can be from about 180° C. to about 300° C. Other operating parameters of hydrotreater 115 may be varied by one of ordinary skill in the art to affect the desired hydrotreatment. For instance, the hydrogen partial pressure is preferably between about 1,000 kPa and about 20,000 kPa, and more preferably between about 2,000 kPa and about 10,000 kPa. For ultra-low severity hydrotreatment, the hydrogen partial pressure is preferably between about 700 kPa and about 6,000 kPa, and more preferably between about 2,000 kPa and about 3,500 kPa. Moreover, the liquid hourly space velocity is preferably between about 1 hr⁻¹ and about 10 hr⁻¹, more preferably between about 0.5 hr⁻¹ and about 6 hr⁻¹, and most preferably between about 1 hr⁻¹ and about 5 hr⁻¹.

Hydrotreated naphtha product 160 is combined with ethanol 170 to produce denatured ethanol 175. Hydrotreated naphtha product 160 can be combined with ethanol 170 by any known method. For instance, as illustrated in FIG. 1, hydrotreated naphtha product 160 is combined with ethanol 170 in vessel 125. Hydrotreated naphtha product 160 and ethanol 170 can be combined in any ratio suitable for producing denatured ethanol 175. For instance, denatured ethanol 175 may comprise about 10 percent or less by volume of hydrotreated naphtha product 160. In alternative embodiments, denatured ethanol 175 may comprise about 5 percent or less by volume of hydrotreated naphtha product 160. It is to be understood that the present invention is not limited to denatured ethanol 175 having such percentages of naphtha but can also include any desired amounts of naphtha higher than about 10 percent by volume. In alternative embodiments (not illustrated), straight-run naphtha distillate 140 may also be used to blend with ethanol 170 to produce denatured ethanol 175.

FIG. 2 illustrates a hydrocarbon synthesis system comprising hydrocarbon synthesis reactor 105, fractionator 110, vessel 125, and hydrocracker 225.

Syngas feed 120 is fed to hydrocarbon synthesis reactor 105. Hydrocarbon synthesis reactor 105 produces light hydrocarbon synthesis product 240 and heavy hydrocarbon synthesis product 245, both of which primarily comprise hydrocarbons. Hydrocarbon synthesis products 240 and 245 may also comprise oxygen-containing hydrocarbons, also called oxygenates, such as olefins, alcohols, aldehydes, and the like. Heavy hydrocarbon synthesis product 245 preferably comprises primarily hydrocarbons with 20 or more carbons atoms, and light hydrocarbon synthesis product 240 preferably comprises primarily hydrocarbons with between about 5 and about 22 carbons atoms.

Heavy hydrocarbon synthesis product 245 is fed to hydrocracker 225 where it is cracked into hydrocracker product 230, which is then sent into fractionator 110. Hydrocracker product 230 preferably comprises middle distillates. Methods of hydrocracking are well known in the art, and hydrocracking of heavy hydrocarbon synthesis product 245 in hydrocracker 225 can include any suitable method. The hydrocracking preferably takes place at temperatures from about 260° C. to about 400° C. and at pressures from about 3,500 kPa to about 20,000 kPa. The hydrocracking preferably takes place over a hydrocracking catalyst comprising an acid component such as an amorphous silica-alumina and/or a zeolite. The hydrocracking catalyst may further comprise a hydrogenation component such as a metal from Groups 8, 9 and 10 in optional combination with a group 6 metal.

Light hydrocarbon synthesis product 240 leaves hydrocarbon synthesis reactor 105 and is combined with hydrocracker product 230 to form fractionator feed 235. Fractionator feed 235 is fed to fractionator 110 where it is separated into distillation cuts, which include a heavy distillate 250, a light distillate 255, middle distillates including a naphtha distillate 260 and a diesel distillate 265. It is to be understood that the present invention is not limited to middle distillates 260 and 265 but can comprise one middle distillate or more than two middle distillates. Methods of fractionation are well known in the art, and fractionator feed 235 can be fractionated in fractionator 110 by any suitable fractionation method. At least a portion of heavy distillate 250 may be recycled to hydrocracker 225.

As in the embodiment of FIG. 1, naphtha distillate 260 and ethanol 170 can be combined in any ratio suitable for producing denatured ethanol 175. For instance, denatured ethanol 175 may comprise about 10.0 percent or less by volume of naphtha distillate 260. In alternative embodiments, denatured ethanol 175 may comprise about 5.0 percent or less by volume of naphtha distillate 260. It is to be understood that the present invention is not limited to denatured ethanol 175 having such percentages of naphtha but can also include any desired amounts of naphtha higher than about 10.0 percent by volume.

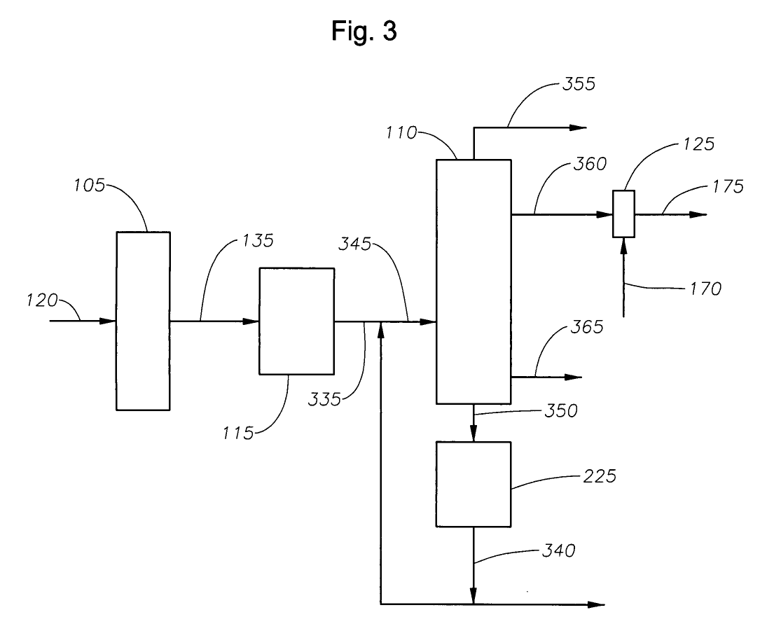

FIG. 3 illustrates a hydrocarbon synthesis system comprising a hydrocarbon synthesis reactor 105, hydrotreater 115, fractionator 110, hydrocracker 225, and vessel 125.

Syngas feed 120 is fed to hydrocarbon synthesis reactor 105, and hydrocarbon synthesis product 135 is produced. Hydrocarbon synthesis product 135 is fed to hydrotreater 115 for hydrotreatment to form hydrotreated hydrocarbon product 335. The hydrotreatment should saturate at least a portion of the olefins in hydrotreated hydrocarbon product 335, preferably saturate substantially all of the olefins. The hydrotreatment may substantially convert all of the oxygenates to paraffins or may allow a substantial amount of the oxygenates to remain unconverted. It is to be understood that the hydrotreatment is similar to the hydrotreatment described in the embodiment of FIG. 1.

Hydrotreated hydrocarbon product 335 leaves hydrotreater 115 and is combined with a portion of hydrocracker product 340 to form fractionator feed 345. Fractionator feed 345 is fed to fractionator 110 where it is separated into distillation cuts, which include a heavy distillate 350, a light distillate 355, middle distillates including a naphtha distillate 360 and a diesel distillate 365. It is to be understood that the present invention is not limited to middle distillates 360 and 365 but can comprise one middle distillate or more than two middle distillates. Methods of fractionation are well known in the art, and fractionator feed 345 can be fractionated in fractionator 110 by any suitable fractionation method.

Heavy distillate 350 is fed to hydrocracker 225 where it is cracked into hydrocracker product 340, which is recycled at least in part into fractionator 110. Hydrocracker product 340 preferably comprises middle distillates. Preferably, hydrocracker product 340 comprises middle distillates with a higher content of isoparaffins than heavy distillate 350. Methods of hydrocracking are well known in the art, and hydrocracking of heavy distillate 350 in hydrocracker 225 can include any suitable method. It is to be understood that the hydrocracking is similar to the hydrocracking conditions and catalysts described in FIG. 2.

Naphtha distillate 360 can be combined with ethanol 170 to produce denatured ethanol 175. Naphtha distillate 360 can be combined with ethanol 170 by any known method. For instance, naphtha distillate 360 can be combined with ethanol 170 in vessel 125. As described in the embodiments above, naphtha distillate 360 and ethanol 170 can be combined in any ratio suitable for producing denatured ethanol 175.

Straight-run diesel distillate 145 and diesel distillates 265, 365 comprise diesel, preferably Fischer-Tropsch diesel. Diesel can have a boiling point range from about 150° C. to about 400° C.; preferably from about 170° C. to about 350° C. Diesel is generally considered to start at about C₁₀ and end at about C₂₀, but can comprise some C₉ and/or can extend to about C₂₂. Depending on the climatic conditions in which the diesel is used, local specifications can allow these limits to be higher or lower. Specifications of diesel fuels can define limits on viscosity, boiling range, density, lubricity, cloud point, pour point, and others. The number of carbon atoms that make up the molecules of a given fuel are a consequence of the tailoring of the fuel to meet those specification requirements. In reality, fuels comprise an array of molecule types.

Straight-run naphtha distillate 140, hydrotreated naphtha product 160, naphtha distillate 260, and naphtha distillate 360 comprise naphtha, preferably Fischer-Tropsch naphtha. It is to be understood that the Fischer-Tropsch diesel and the Fischer-Tropsch naphtha are distillates produced when hydrocarbon synthesis reactor 105 is a Fischer-Tropsch reactor. Naphtha has a boiling point of from about 25° C. to about 180° C., preferably from about 40° C. to about 170° C. Naphtha is generally considered to start at about C₅ and end at about C₉ but can comprise some C₄ and/or can extend to about C₁₁. Naphtha preferably has a density of from about 0.65 g/ml to about 0.80 g/ml, and more preferably about 0.66-0.74 g/ml. In addition, naphtha preferably has a sulfur content of less than about 50 ppm S, preferably less than about 10 ppm S, more preferably less than about 5 ppm S, still more preferably less than about 1 ppm S. Moreover, naphtha preferably has an aromatics content of less than about 10,000 ppm, preferably less than about 5,000 ppm, more preferably less than about 5,000 ppm, still more preferably less than about 1,000 ppm, yet still more preferably less than about 500 ppm. In addition, naphtha preferably has an oxygenates content of less than about 5 wt. %, preferably less than about 2 wt. %. In addition, naphtha can have from about 5 to about 11 carbons in its constituent molecules. The naphtha comprises mainly paraffins, with a paraffinic content greater than 80 wt. %, preferably greater than 90 wt. %, still more preferably greater than 95 wt. %. In preferred embodiments, naphtha primarily comprises C₅ to C₉ paraffins, but can further comprise some other paraffins with lower or higher carbon numbers. Naphtha further comprises at most 15 wt. % olefins, preferably not more than 10 wt. %. It is to be understood that the naphtha is not limited to the above-identified property values but can include higher or lower values depending on factors such as the process conditions.

It should be understood by those of ordinary skill in the art that producing a fraction or a distillate (whether it be a diesel fraction, a naphtha fraction and the like) with a definite carbon number cutoff, e.g., 9 or 10 carbon atoms or a temperature, e.g., 170° C. or 180° C., is generally very difficult and expensive, although not impossible. The reality, especially in industrial settings, is that a distillation process targeting a cutoff of a specified carbon number or temperature for a fraction will still allow a small amount of material above or below the target to be entrained into the fraction for various reasons. For example, no two fractions of “diesel” are exactly the same in composition and/or end boiling point, however, it still is designated and sold as “diesel.” It is therefore intended that these explicitly specified fractions may contain a small amount of other material. The amount outside the targeted range will generally be determined by how much time and expense the user is willing to expend and/or by the limitations of the type of fractionation technique or equipment available.

Regulations and statutes typically set forth formulas specifying the blending requirements for denaturing ethanol. For instance, Federal Regulations require 195 proof or greater ethanol to be denatured by the following formula: to every 100 gallons of ethanol add a total of 2.0 gallons of either unleaded gasoline, rubber hydrocarbon solvent, kerosene, or deodorized kerosene, or any combination of such. Hydrotreated naphtha product 160 and naphtha distillates 260 and 360, preferably comprising Fischer-Tropsch naphtha, may all be used as a denaturant in place of the conventional denaturants of the Federal Regulations. Therefore, to comply with the Federal Regulations, 2.0 gallons of hydrotreated naphtha product 160, naphtha distillate 260 and/or naphtha distillate 360 can be blended with 100 gallons of ethanol 170 to produce denatured ethanol 175.

One could further add to denatured ethanol 175 one or more denaturants such as acetone, diethyl phthalate, ethyl acetate, gasoline, benzene, methanol, isopropyl alcohol, citronella, pyridine bases, soaps, wood alcohol, brucine sulfate, and the like.

Denatured ethanol 175 could comprise a completely denatured alcohol (CDA) by employing hydrotreated naphtha product 160, naphtha distillate 260 and/or naphtha distillate 360 as one denaturant, wherein the denatured ethanol 175 as a CDA can comprise a minimum level of denaturant (about 5 percent by volume).

In alternate embodiments, denatured ethanol 175 could comprise a specially denatured alcohol (SDA) by employing hydrotreated naphtha product 160, naphtha distillate 260 and/or naphtha distillate 360 as one denaturant, wherein the denatured ethanol 175 as a SDA can comprise a maximum level of denaturant (about 10 percent by volume). Denatured ethanol 175 as a SDA preferably comprises at least about 1 percent by volume of the denaturant. In other embodiments, denatured ethanol 175 could be used to form a denatured SDA that typically employs more than one denaturant. One of the denaturants would be hydrotreated naphtha product 160, naphtha distillate 260 and/or naphtha distillate 360, while another denaturant would be a conventional denaturant.

In alternative embodiments (not illustrated), denatured ethanol 175 can be combined with liquids such as personal care products (such as cosmetics), flavors, fragrances, fuels (preferably gasoline), antifreeze, chemicals (such as varnish), rubbing alcohols, and the like to produce a liquid product. Personal care products can comprise any known toiletries, cosmetic or dermatological compositions. Denatured ethanol 175 can be combined with the liquids in any desired ratio. For instance, government specifications for a fuel may require a desired ratio of ethanol to be blended with gasoline. In such instances, denatured ethanol 175 can be blended with gasoline in desired amounts sufficient to satisfy the government specifications for fuel use.

In alternative embodiments (not illustrated), denatured ethanol 175 can be employed in a dermatological or cosmetic formulation, which may be in the form of a liquid, a lotion, an oil, a paste, a cream, a shampoo, a powder, an ointment, a gel, or an emulsion.

To further illustrate various illustrative embodiments of the present invention, the following examples are provided.

### EXAMPLE 1

About 10.0 gallons of 195 proof ethanol is combined with about 0.2 gallons of Fischer-Tropsch naphtha to form a denatured ethanol. The Fischer-Tropsch naphtha comprising 200 gallons of gasoline is then blended with 4 gallons of the denatured ethanol to make 204 gallons of formulated gasoline with a 5% denatured ethanol by volume. The resulting denatured ethanol is then blended with about 204.0 gallons of gasoline. Under federal regulations, the resulting gasoline mixture is suitable for use in automobiles.

### EXAMPLE 2

About 5.0 gallons of 200 proof ethanol is combined with about 0.1 gallons of Fischer-Tropsch naphtha. The resulting denatured ethanol is then blended with about 51.0 gallons of gasoline. Under federal regulations, the resulting gasoline is suitable for use in automobiles.

It will be understood that the present invention is not limited to the above-identified steps and equipment for producing naphtha or diesel and combining such with ethanol 170 to produce denatured ethanol 175. The present invention further includes any suitable combination of such steps and/or equipment as well as any additional steps and/or equipment suitable for producing naphtha and/or combining it with ethanol 170 to produce denatured ethanol 175. For instance, alternative embodiments (not illustrated) of FIG. 1 may include hydrocracking upstream of fractionator 110. Additional alternative embodiments (not illustrated) include the embodiments of FIG. 2 comprising hydrotreating downstream and/or upstream of fractionator 110, or hydrotreating light hydrocarbon synthesis product 240 before it is sent to fractionator 110. Further alternative embodiments (not illustrated) include the embodiments of FIG. 3 comprising not recycling hydrocracker product 340 or not hydrocracking heavy distillate 350. Moreover, the present invention is not limited to combining hydrotreated naphtha product 160 or naphtha distillates 260, 360 with ethanol 170 to produce denatured ethanol 175, but also includes using hydrotreated naphtha product 160 or naphtha distillates 260, 360 to denature any other liquid that can be denatured. For instance, butanol, paints, dyes, and the like can be denatured with such naphthas. Such naphthas can also be used to denature a blend of ethanol and at least one of alcohols such as butanol, paints, dyes and the like. Further alternative embodiments include combining hydrotreated naphtha product 160, naphtha distillate 260, or naphtha distillate 360 and at least one conventional denaturant with ethanol to denature the ethanol and/or the liquids that can be denatured. Conventional denaturants include toluene, vinegar, methanol, low-sulfur gasoline, and the like.

Although the present invention and its advantages have been described in detail, it should be understood that various changes, substitutions and alterations may be made herein without departing from the spirit and scope of the invention as defined by the appended claims.

What is claimed is:

1. A denatured liquid, wherein the denatured liquid comprises a liquid and a naphtha, and wherein the naphtha is derived at least in part by a Fischer-Tropsch synthesis.

2. The denatured liquid of claim 1, wherein the liquid comprises ethanol.

3. The denatured liquid of claim 1, wherein the liquid comprises at least one of alcohols, paints, and dyes.

4. The denatured liquid of claim 1, wherein the denatured liquid comprises about 5 percent or less by volume of naphtha, and wherein the naphtha is derived at least in part by a Fischer-Tropsch synthesis.

5. The denatured liquid of claim 1, wherein the denatured liquid comprises about 10 percent or less by volume of naphtha, and wherein the naphtha is derived at least in part by a Fischer-Tropsch synthesis.

6. The denatured liquid of claim 1, further comprising a conventional denaturant.

7. A liquid product, the liquid product comprising:
a denatured liquid, wherein the denatured liquid comprises a naphtha, and wherein the naphtha is derived at least in part by a Fischer-Tropsch synthesis; and
a second liquid.

8. The liquid product of claim 7, wherein the denatured liquid comprises ethanol.

9. The liquid product of claim 7, wherein the denatured liquid comprises at least one of alcohols, paints, and dyes.

10. The liquid product of claim 7, wherein the denatured liquid comprises about 5 percent or less by volume of naphtha, and wherein the naphtha is derived at least in part by a Fischer-Tropsch synthesis.

11. The liquid product of claim 7, wherein the denatured liquid comprises about 10 percent or less by volume of naphtha, and wherein the naphtha is derived at least in part by a Fischer-Tropsch synthesis.

12. The liquid product of claim 7, wherein the second liquid comprises at least one of a cosmetic, a fuel, antifreeze, a chemical, and rubbing alcohol.

13. The liquid product of claim 12, wherein the fuel is gasoline.

14. A method for denaturing a liquid with a naphtha, wherein the naphtha is derived at least in part by a Fischer-Tropsch synthesis, the method comprising:
(A) exposing the liquid to the naphtha; and
(B) combining the liquid and the naphtha sufficient to denature the liquid.

15. The method of claim 14, wherein the liquid comprises ethanol.

16. The method of claim 14, further comprising
(C) combining the denatured liquid with at least one of a cosmetic, a fuel, antifreeze, chemicals, and rubbing alcohol.

17. The method of claim 16, wherein the fuel is gasoline.

18. A method for producing a denatured liquid, the method comprising:
(A) feeding a syngas to a hydrocarbon synthesis reactor, wherein the syngas is reacted to produce a hydrocarbon synthesis product;
(B) producing a naphtha from the hydrocarbon synthesis product; and
(C) combining the naphtha with a liquid to denature the liquid.

19. The method of claim 18, wherein the liquid comprises ethanol.

20. The method of claim 18, wherein the liquid comprises at least one of alcohols, paint, and dyes.

21. The method of claim 18, wherein the hydrocarbon synthesis reactor of step (A) comprises a Fischer-Tropsch reactor.

22. The method of claim 18, wherein step (B) further comprises at least one of hydrotreating, hydrocracking, and fractionating the hydrocarbon synthesis product.

23. The method of claim 22, wherein a product of hydrotreating the hydrocarbon synthesis product is fractionated to produce the naphtha.

24. The method of claim 22, wherein a product of hydrocracking the hydrocarbon synthesis product is fractionated to produce the naphtha.

25. The method of claim 22, wherein the naphtha is hydrotreated after it is produced by fractionating the hydrocarbon synthesis product.

26. The method of claim 22, wherein step (B) further comprises hydrocracking a heavy distillate, wherein the heavy distillate is produced from fractionating the hydrocarbon synthesis product.

27. The method of claim 18, wherein the naphtha is derived at least in part by a Fischer-Tropsch synthesis.

28. The method of claim 18, further comprising
(D) combining the denatured liquid with at least one of a cosmetic, a fuel, antifreeze, chemicals, and rubbing alcohol.

29. The method of claim 28, wherein the fuel is gasoline.
